(19) United States
(12) Patent Application Publication
(10) Pub. No.: US 2004/0215761 A1
(43) Pub. Date: Oct. 28, 2004

(54) Network management system

(76) Inventors: Yasuki Fujii, Kawasaki (JP); Keiji Miyazaki, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/773,839

(22) Filed: Feb. 5, 2004

(30) Foreign Application Priority Data
Mar. 20, 2003 (JP) 2003-078380

(51) Int. Cl. G06F 15/173

(52) U.S. Cl. 709/223

(57) ABSTRACT

A network management system in which usability and efficiency in management and maintenance of a network are improved. In the network management system, a network decomposition unit decomposes the network into network components, a table management unit manages information on the decomposition of the network into the network components by tabulating the information on the decomposition, and a virtual-network generation unit generates a virtual network as a new area to be managed, by combining the network components based on the information on the decomposition.

### BACKGROUND OF THE INVENTION

1) Field of the Invention

The present invention relates to a network management system which manages a network.

2) Description of the Related Art

In recent years, there have been demands for various information and network services, and information infrastructures for providing such information and network services have been growing and becoming complex. Under such circumstances, techniques for managing networks have been becoming more important, and demands for improvement in functionality for management and maintenance have been increasing.

In order to manage and maintain a network and nodes (network elements or NEs) which constitute the network, network management systems (NMSs) are used. The network management systems are also called element management systems (EMSs).

Normally, a plurality of areas are defined in the network, and the network is managed on an area-by-area basis. Such areas are called subnetworks (SNs), and connections through the subnetworks are called subnetwork connections (SNCs).

Since subnetworks belong to a hierarchic structure, it is possible to regard each node per se as a subnetwork. In this case, it is possible to regard a path connecting an input port and an output port of each node as a subnetwork connection.

FIG. 23 is a diagram illustrating a structure of a network. The network 100 contains nodes N1 through N8. The node N1 is connected to the nodes N2 and N8, the node N2 is connected to the node N3, the node N8 is connected to the node N7, and the node N5 is connected to the nodes N4 and N6. The nodes N3, N4, N6, and N7 are connected to form a ring, i.e., constitute a ring network (which is referred to a core ring CR1). It is assumed that this ring network is registered as a managed area in advance.

An increasing number of large-scale networks have a system topology in which ring networks are interconnected. In such networks, a ring network which has a function of a core of the network is called a core ring. In the network 100 of FIG. 23, a network management system (NMS) 101 is connected to the node N6.

An example of an operation for managing the network 100 in a conventional manner is explained below. In the following example, a portion N1-N2-N5-N8 of the network 100 containing the nodes N1, N2, N5, and N8 is registered as a virtual ring VR1.

The virtual ring VR1 is a managed area. Since a managed area as above can be regarded as a virtual ring network in management, the above managed area is called a virtual ring.

When a network administrator (operator) registers the virtual ring VR1 through the NMS 101, first, a subnetwork connection between the nodes N3 and N4 and a subnetwork connection between the nodes N6 and N7 are generated.

Next, the operator designates the nodes N1, N2, N5, and N8, and the fibers L1, L2, L8, L9, L3, and L4 connecting these nodes. Then, the operator checks whether or not transmission capacities of the fibers are consistent with the transmission capacity of subnetworks established in the core ring CR1, i.e., whether or not it is possible to transmit information corresponding to the transmission capacity of the subnetworks established in the core ring CR1, through the fibers in the virtual ring VR1.

For example, in the case where the transmission capacity of each fiber in the virtual ring VR1 is 150 Mbps, and the transmission capacity of the subnetworks established in the core ring CR1 is 150 Mbps, it is possible to transmit information with a capacity up to 150 Mbps through the fibers in the virtual ring VR1. Therefore, in this case, it is possible to register the virtual ring VR1.

According to a conventionally proposed technique (for example, as disclosed in Japanese Unexamined Patent Publication No. 5-22405, paragraph Nos. 0008 to 0017 and FIG. 1), relationships between logical routes of calls and a physical construction including transmission lines as main constituents are visually illustrated for management of a network.

However, according to the technique disclosed in Japanese Unexamined Patent Publication No. 5-22405, only logical routes passing through physical routes are visually illustrated. Therefore, it is impossible to newly generate, register, and manage a network.

On the other hand, when a virtual ring is generated in the conventional construction for network management as illustrated in FIG. 23, the operator is required to perform bothersome operations for designation of individual nodes, establishing of subnetwork connections, checking of the construction, and the like. Therefore, it takes much time to perform the above operations, and the usability and efficiency in management and maintenance are low.

### SUMMARY OF THE INVENTION

The present invention is made in view of the above problems, and the object of the present invention is to provide a network management system which improves usability and efficiency in management and maintenance of a network.

In order to accomplish the above object, a network management system for managing a network is provided. The network management system comprises: a network decomposition unit which decomposes the network into network components; a table management unit which manages information on decomposition of the network into the network components by tabulating the information on decomposition; and a virtual-network generation unit which generates a virtual network as a new area to be managed, by combining the network components based on information managed by the table management unit.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

In the drawings:

FIG. 1 is a diagram illustrating the principle of the network management system according to the present invention;

FIG. 2 is a diagram provided for explaining subnetwork connections;

FIG. 3 is a diagram illustrating a construction of a network;

FIG. 4 is a diagram illustrating an example of decomposition of a network;

FIG. 5 is a diagram illustrating an example of a branch information table;

FIG. 6 is a diagram illustrating an example of a core information table;

FIG. 7 is a diagram illustrating an example of a connection information table;

FIG. 8 is a flow diagram illustrating an outline of operations for generating a virtual ring;

FIG. 9 is a diagram illustrating subnetwork connections in a core ring;

FIG. 10 is a diagram illustrating a problem which can occur in the case where subnetworks pass through an identical link;

FIG. 11 is a diagram illustrating an example of a virtual-network information table;

FIG. 12 is a diagram illustrating a situation in which a working path and a protection path are established through a virtual ring;

FIG. 13 is a diagram provided for explaining a reason why an unprotected channel is selected;

FIG. 14 is a diagram illustrating an example of a protection information table;

FIG. 15 is a diagram illustrating an example of a path information table;

FIG. 16 is a diagram illustrating an example of generation of a virtual ring;

FIG. 17 is a diagram illustrating an example of an SNC information table;

FIG. 18 is a diagram illustrating an example of addition of a branch network to a virtual ring;

FIG. 19 is a diagram illustrating an example of display of a virtual ring;

FIG. 20 is a diagram illustrating an example of display of a virtual ring;

FIG. 21 is a diagram illustrating an example of display of a virtual ring;

FIG. 22 is a diagram illustrating an example of a virtual-line information table; and

FIG. 23 is a diagram illustrating a conventional construction of a network.

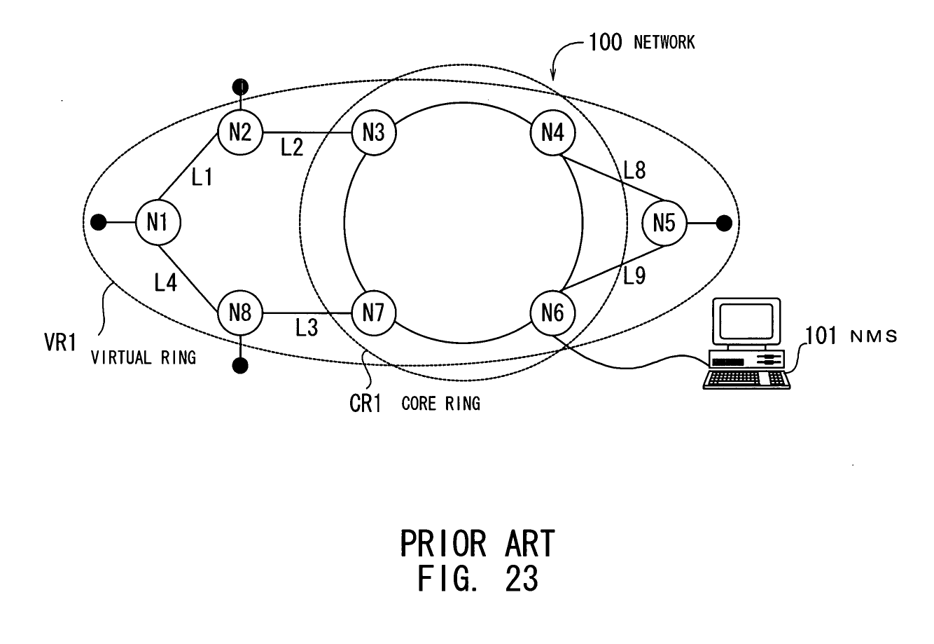

### DESCRIPTION OF THE PREFERRED EMBODIMENTS

An embodiment of the present invention is explained in detail below with reference to drawings.

Principle of the Invention

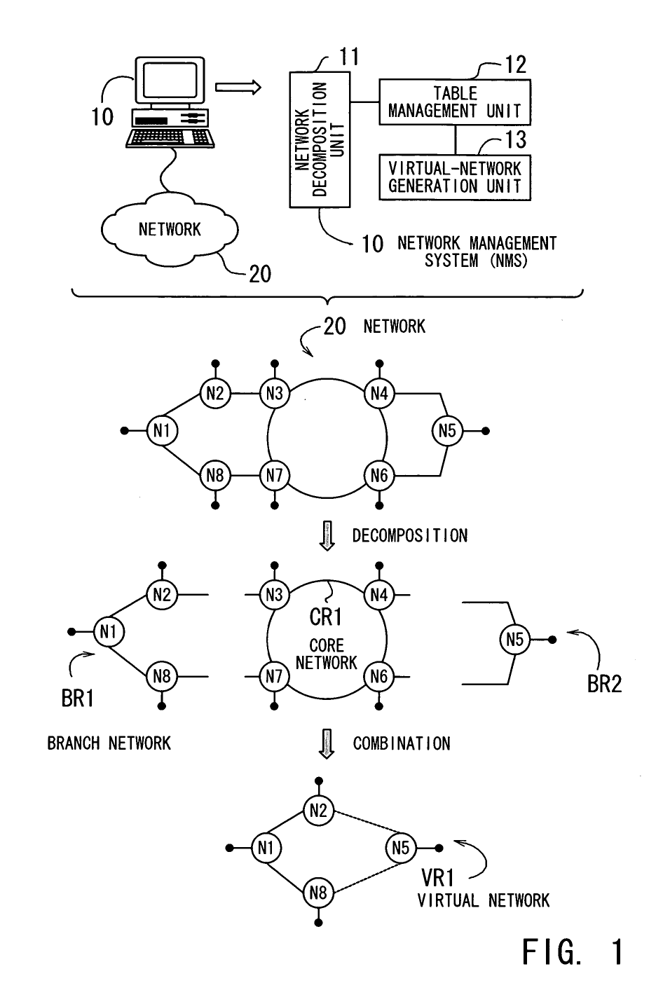

FIG. 1 is a diagram illustrating the principle of the network management system (NMS) 10 according to the present invention. The NMS 10 comprises a network decomposition unit 11, a table management unit 12, and a virtual-network generation unit 13, and manages the network 20.

The NMS 10 is logically connected to each node in the network 20, and can perform communication with each node. (The logical connection to all nodes can be established by physically connecting the NMS 10 with any of the nodes in the network 20.)

The network decomposition unit 11 decomposes a network into elements, and groups the elements into network components including at least one core network and branch networks. The table management unit 12 manages information on the decomposition into the network components as decomposition information by tabulating the decomposition information into tables.

The tables include a branch information table for managing information on structures of branch networks, a core information table for managing information on structures of at least one core network, a connection information table for managing information on connections between the at least one core network and the branch networks, a virtual-network information table for managing information on structures of virtual networks after generation of the virtual networks, and the like. Details of the tables are explained later.

The virtual-network generation unit 13 generates a virtual network as a new managed area (area to be managed), by combining branch networks based on the tabulated information.

For example, in the case of FIG. 1, in advance, the network decomposition unit 11 decomposes the network 20 (which contains the nodes N1 through N8 connected to each other as illustrated in FIG. 1) into the core ring CR1, the branch networks BR1 and BR2, and the like, and the table management unit 12 tabulates information on the decomposition.

When an operator registers a portion N1-N2-N5-N8 of the network 20 containing the nodes N1, N2, N5, and N8 as a managed area, the virtual-network generation unit 13 generates a virtual network VR1 comprised of the nodes N1, N2, N5, and N8 by automatically combining the branch networks BR1 and BR2 based on the tabulated information in response to one operation of designation.

That is, the network management system according to the present invention has such a construction that information on decomposition of the network 20 into a plurality of network components is stored in advance, and a virtual network which is to be generated as a managed area is automatically generated based on the information on the decomposition. Therefore, the operator is not required to perform the bothersome operations which are conventionally required for generating a virtual network, i.e., the operability of the network management system is greatly improved. Thus, it is possible to improve usability and efficiency in management and maintenance of the network.

Subnetwork Connections

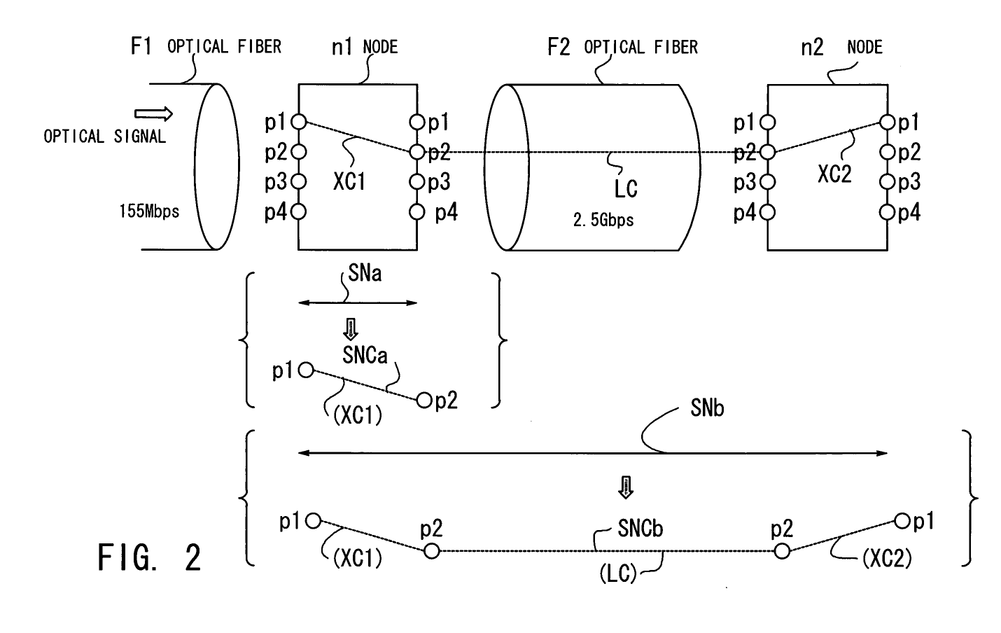

Next, subnetwork connections are explained below. FIG. 2 is a diagram provided for explaining subnetwork connections. In FIG. 2, each of the nodes n1 and n2 has ports p1 through p4 on each of input and output sides. That is, each of the nodes n1 and n2 enables 4-channel crossconnecting operations. The node n1 is connected to an optical fiber F1 having a transmission capacity up to 155 Mbps and an optical fiber F2 having a transmission capacity up to 2.5 Gbps, and the node n2 is connected to the optical fiber F2.

In addition, the node n1 performs a crossconnecting operation in which the line XC1 receives an optical signal from the port 1, and outputs the optical signal from the port 2. The optical signal outputted from the node n1 passes through a link connection LC in the optical fiber F2, and enters the node n2. The node n2 also performs a crossconnecting operation in which the line XC2 receives the optical signal from the port 2, and outputs the optical signal from the port 1.

When the node n1 is regarded as a subnetwork SNa, the line XC1 is a subnetwork connection SNCa. In addition, when a portion comprised of the node n1, the optical fiber F2, and the node n2 is regarded as a subnetwork SNb, the line XC1, the link connection LC, and the line XC2 constitute a subnetwork connection SNCb.

Operations of NMS

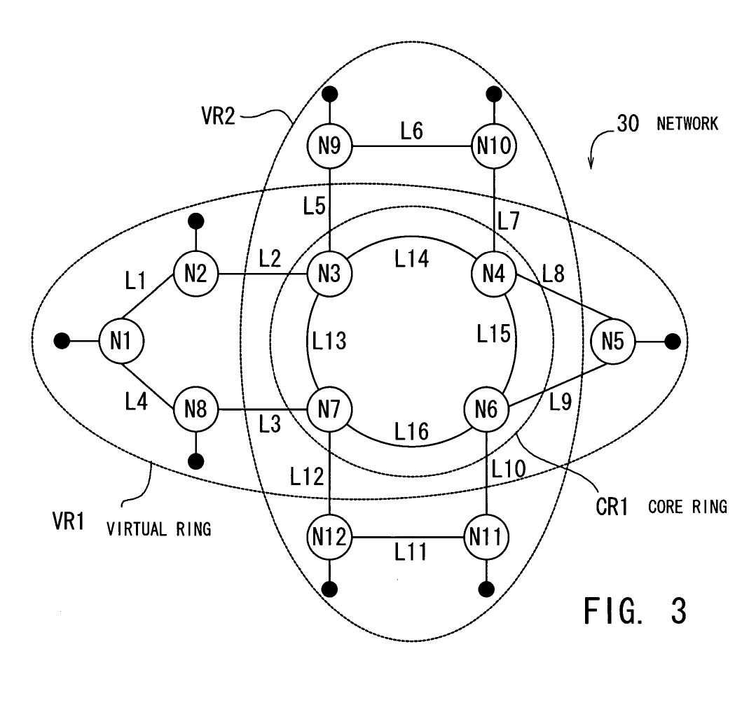

Hereinbelow, operations of the NMS 10 according to the present invention are explained in detail. In the following explanations, a case in which networks have a ring topology is taken as an example. FIG. 3 is a diagram illustrating a construction of a network. The network 30 in FIG. 3 contains nodes N1 through N12.

In the network 30, the link L1 connects the nodes N1 and N2, the link L2 connects the nodes N2 and N3, the link L5 connects the nodes N3 and N9, the link L6 connects the nodes N9 and N10, the link L7 connects the nodes N10 and N4, and the link L8 connects the nodes N4 and N5, where the links are physical transmission lines connecting nodes.

In addition, the link L4 connects the nodes N1 and N8, the link L3 connects the nodes N8 and N7, the link L12 connects the nodes N7 and N12, the link L11 connects the nodes N12 and N11, the link L10 connects the nodes N11 and N6, and the link L9 connects the nodes N6 and N5. Further, the link L14 connects the nodes N3 and N4, the link L15 connects the nodes N4 and N6, the link L16 connects the nodes N6 and N7, and the link L13 connects the nodes N7 and N3.

The nodes N3, N4, N6, and N7 constitute a core ring CR1. It is assumed that the links L13 through L16 have a bandwidth of 2.4 Gbps, and the core ring CR1 is a ring network in which subnetwork connections each having a bandwidth of 150 Mbps can be generated. In addition, it is also assumed that the bandwidths of the links L1, L2, L4, L3, L5, L6, L7, L8, L9, L10, L11, and L12 which connect the eight nodes N1, N2, N8, N9, N10, N5, N11, and N12 (other than the above nodes N3, N4, N6, and N7 constituting the core ring CR1) are 150 Mbps, and subnetwork connections each having a bandwidth of 1.5 Mbps can be generated through the links L1, L2, L4, L3, L5, L6, L7, L8, L9, L10, L11, and L12. In FIG. 3, the NMS 10 is not shown.

In the network 30 having the above structure, a virtual ring VR1 is generated by determining a network constituted by the nodes N1, N2, N5, and N8 to be a managed area, and a virtual ring VR2 is generated by determining a network constituted by the nodes N9, N10, N11, and N12 to be a managed area.

That is, the operator wishes to regard the virtual ring VR1 as a ring network constituted by only the nodes N1, N2, N5, and N8 by hiding the core ring CR1, and the virtual ring VR2 as a ring network constituted by only the nodes N9, N10, N11, and N12 by hiding the core ring CR1. Although, in FIG. 3, the core ring CR1 is indicated inside each of the virtual rings VR1 and VR2, the core ring CR1 is not an explicit constituent of each of the virtual rings VR1 and VR2.

In the following explanations, a particular emphasis is placed on a process for generating the virtual ring VR1 in the network 30.

Network Decomposition Unit

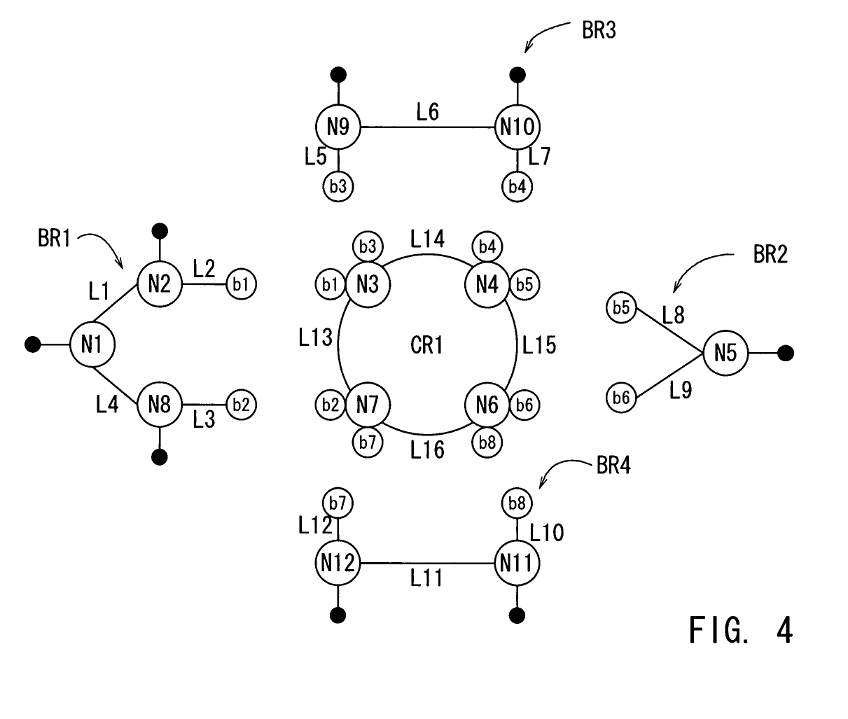

First, the network decomposition unit 11 is explained below. FIG. 4 is a diagram illustrating an example of decomposition of the network 30.

The network decomposition unit 11 decomposes the network 30 into elements, and groups the elements into network components including the core ring CR1 and the branch networks BR1 through BR4. When the elements obtained by the decomposition are grouped into the branch networks, the branch networks are cut out from the network 30 in such a manner that the branch networks do not overlap each other. In addition, in FIG. 4, each of the branch networks cut out (grouped) as above is connected to the core ring CR1 at two points.

The core ring CR1 contains the nodes N3, N4, N6, and N7 and the links L13 through L16, the branch network BR1 contains the nodes N1, N2, and N8 and the links L1 through L4, the branch network BR2 contains the node N5 and the links L8 and L9. the branch network BR3 contains the nodes N9 and N10 and the links L5 through L7, and the branch network BR4 contains the nodes N11 and N12 and the links L10 through L12.

In FIG. 4, the connection points (branch connection points) at which the branch network BR1 through BR4 are connected to the core ring CR1 are indicated by the references b1 through b8. For example, when the branch connection points b1 are joined, the nodes N2 and N3 are connected through the link L2. In FIG. 4, end points of the network 30 are indicated by black (filled) circles.

Table Management Unit

Next, the table management unit 12 is explained. The table management unit 12 manages the information on the decomposition of the network 30 by the network decomposition unit 11, by using a branch information table T1, a core information table T2, and a connection information table T3.

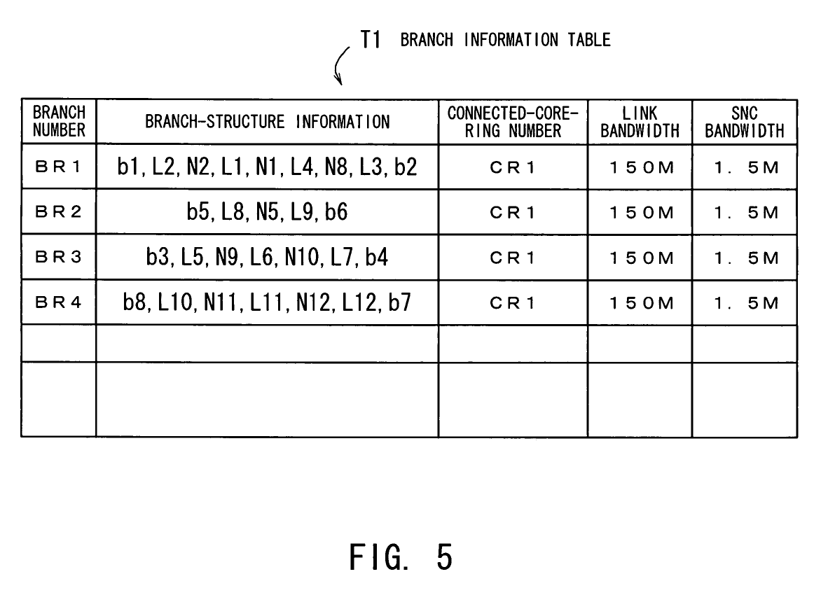

FIG. 5 is a diagram illustrating an example of the branch information table T1. The branch information table T1 is a table for managing information on the structures of the branch networks, and includes fields of “BRANCH NUMBER,” “BRANCH-STRUCTURE INFORMATION,” “CONNECTED-CORE-RING NUMBER,” “LINK BANDWIDTH,” and “SNC (SUBNETWORK CONNECTION) BANDWIDTH.”

In the branch information table T1, the branch number “BR1” indicates the branch network BR1, and the numbers indicating the branch connection points, links, and nodes in the branch network BR1 are indicated in the field of “BRANCH-STRUCTURE INFORMATION” in correspondence with the branch number “BR1.” For example, the numbers “b1, L2, N2, L1, N1, L4, N8, L3, b3” are indicated in the field of “BRANCH-STRUCTURE INFORMATION.”

In addition, since the branch network BR1 is connected to the core ring CR1, the number “CR1” of the core ring CR1 is indicated in the field of “CONNECTED-CORE-RING NUMBER.” Further, since each link in the branch network BR1 has a bandwidth of 150 Mbps, “150M” is indicated in the field of “LINK BANDWIDTH.” Furthermore, since the bandwidth of each subnetwork connection is assumed to be 1.5 Mbps, “1.5M” is indicated in the field of “SNC bandwidth.” Similarly, the respective fields for the other branch networks BR2 through BR4 are filled with applicable information.

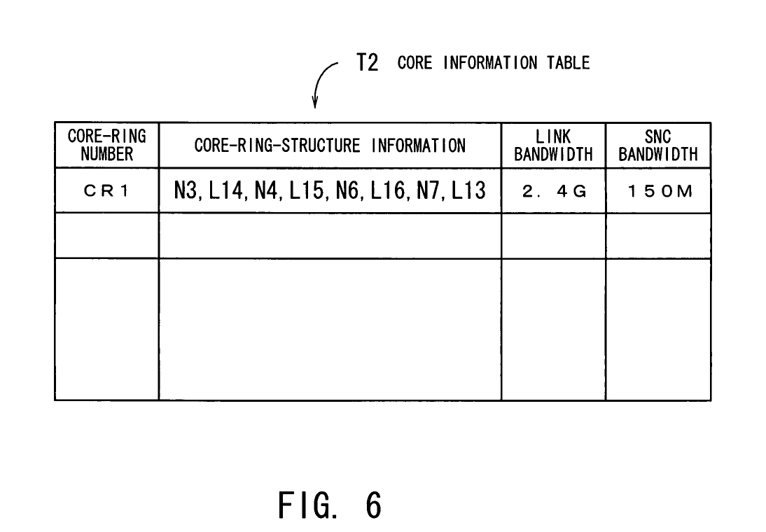

FIG. 6 is a diagram illustrating an example of the core information table T2. The core information table T2 is a table for managing the information on the structure of the core ring, and includes fields of “CORE-RING NUMBER,” “CORE-RING-STRUCTURE INFORMATION,” “LINK BANDWIDTH,” and “SNC BANDWIDTH.”

In the core information table T2, the core-ring number “CR1” indicates the core ring CR1, and the numbers indicating the links and nodes in the core ring CR1 are indicated in the field of “CORE-RING-STRUCTURE INFORMATION” in correspondence with the branch number “BR1.” For example, the numbers “N3, L14, N4, L15, N6, L16, N7, L13” are indicated in the field of “CORE-RING-STRUCTURE INFORMATION.”

In addition, since each of the links L13 through L16 in the core ring CR1 has a bandwidth of 2.4 Gbps, “2.4 G” is indicated in the field of “LINK BANDWIDTH.” Further, since the bandwidth of each subnetwork connection is assumed to be 150 Mbps, “150M” is indicated in the field of “SNC BANDWIDTH.”

Alternatively, it is possible to indicate “N3, N6, N4, N7” in the field of “CORE-RING-STRUCTURE INFORMATION.” In this case, subnetwork connections are established through the crossed connections between the nodes N3 and N6 and between the nodes N4 and N7, although details of this case are not shown.

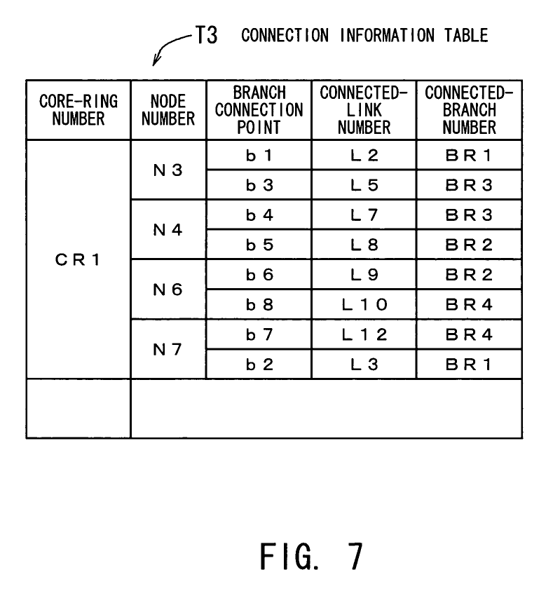

FIG. 7 is a diagram illustrating an example of the connection information table T3. The connection information table T3 is a table for managing information on connections between the at least one core ring and the branch networks, and includes fields of “CORE-RING NUMBER,” “NODE NUMBER,” “BRANCH CONNECTION POINT,” “CONNECTED-LINK NUMBER,” and “CONNECTED-BRANCH NUMBER.”

For example, the information on connections corresponding to the branch network BR1 and the node N3 in the core ring CR1 includes the branch connection “b1” and the connected link “L2.” In addition, the information on connections corresponding to the branch network BR3 and the node N3 in the core ring CR1 includes the branch connection “b3” and the connected link “L5.” Similarly, the respective fields for the other nodes N4, N6, and N7 are filled with applicable information.

Generation of Virtual Ring

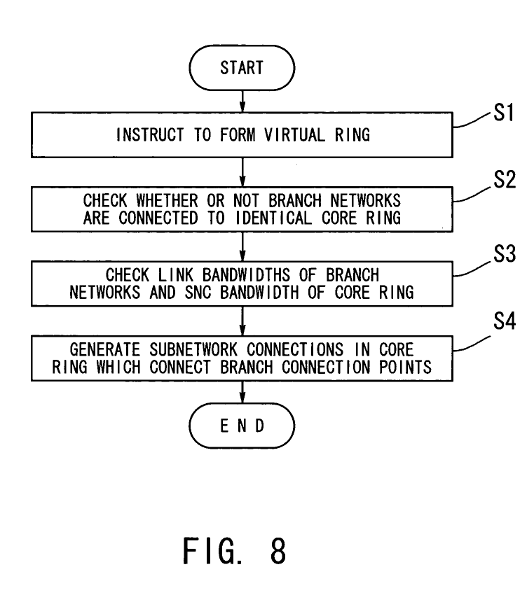

Next, operations for generating the virtual ring VR1 by the virtual-network generation unit 13 are explained below. FIG. 8 is a flow diagram illustrating an outline of the operations for generating the virtual ring VR1.

[S1] The operator designates the branch numbers “BR1” and “BR2” in the branch information table T1 in order to instruct the NMS 10 to generate the virtual ring VR1. The manual operation which the operator is required to perform is this designation only.

[S2] The virtual-network generation unit 13 refers to the branch information table T1 for the connected-core numbers corresponding to the designated branch numbers “BR1” and “BR2,” and checks whether or not the designated branch networks BR1 and BR2 are connected to the identical core ring CR1, based on the connected-core numbers.

[S3] The virtual-network generation unit 13 refers to the branch information table T1 for the link bandwidths (“150M”) corresponding to the designated branch numbers “BR1” and “BR2,” and checks whether or not the link bandwidths of the designated branch networks BR1 and BR2 do not exceed the value (“150M”) of the SNC bandwidth of the core ring CR1 indicated in the core information table T2.

[S4] The virtual-network generation unit 13 extracts the branch connection points (b1, b2, b5, b6) at which the designated branch networks BR1 and BR2 are connected to the core ring CR1, and generates subnetwork connections which pass through the core ring and connect the extracted branch connection points, based on the connection information table T3.

In the above sequence, the virtual ring VR1 is automatically generated. However, when subnetwork connections in the core ring CR1 are generated in step S4, it is necessary to establish the subnetwork connections in such a manner that two or more of the subnetwork connections do not pass through an identical link, e.g., the subnetwork connection connecting the branch connection points b1 and b5 and the subnetwork connection connecting the branch connection points b2 and b6 do not share an identical link.

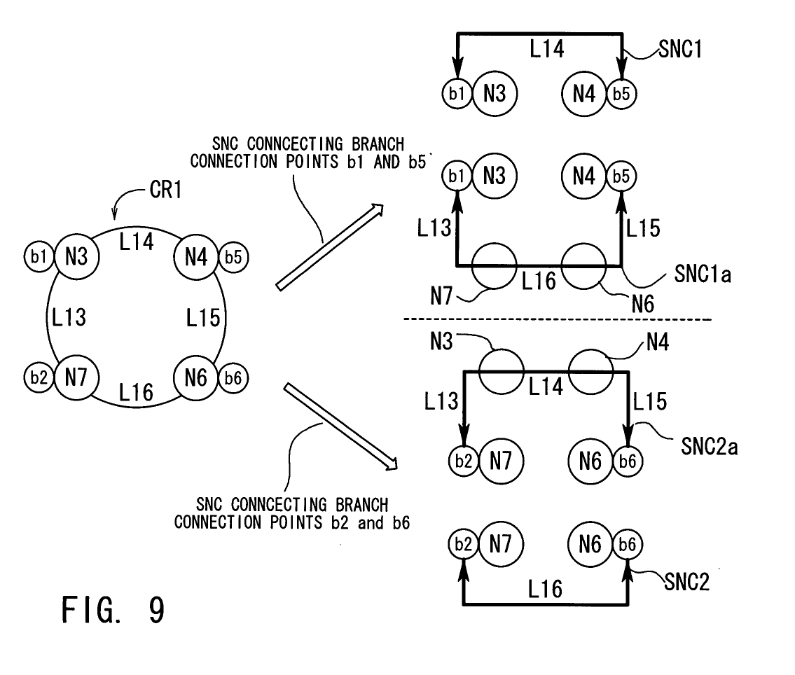

FIG. 9 is a diagram illustrating subnetwork connections in a core ring. When a virtual ring is generated, a subnetwork connection is generated between the branch connection points b1 and b5 in the core ring CR1, and a subnetwork connection is generated between the branch connection points b2 and b6 in the core ring CR1.

Generally, when a subnetwork connection is established between the branch connection points b1 and b5, either of a subnetwork connection SNC1 passing through an upper path in the core ring CR1 and a subnetwork connection SNC1a passing through a lower path in the core ring CR1 can be considered to be established. In addition, when a subnetwork connection is established between the branch connection points b2 and b6, either of a subnetwork connection SNC2a passing through an upper path in the core ring CR1 and a subnetwork connection SNC2 passing through a lower path in the core ring CR1 can be considered to be established.

However, since the subnetwork connection connecting the branch connection points b1 and b5 and the subnetwork connection connecting the branch connection points b2 and b6 should not pass through an identical link, the subnetwork connection SNC1 is selected as the subnetwork connection connecting the branch connection points b1 and b5, and the subnetwork connection SNC2 is selected as the subnetwork connection connecting the branch connection points b2 and b6. If two subnetwork connections are established in the core ring CR1 in such a manner that the two subnetwork connections pass through an identical link (e.g., if the subnetwork connections SNC1 and SNC2a are selected), it is impossible to perform protection control in the virtual ring when a trouble occurs in the link through which the two subnetwork connections pass.

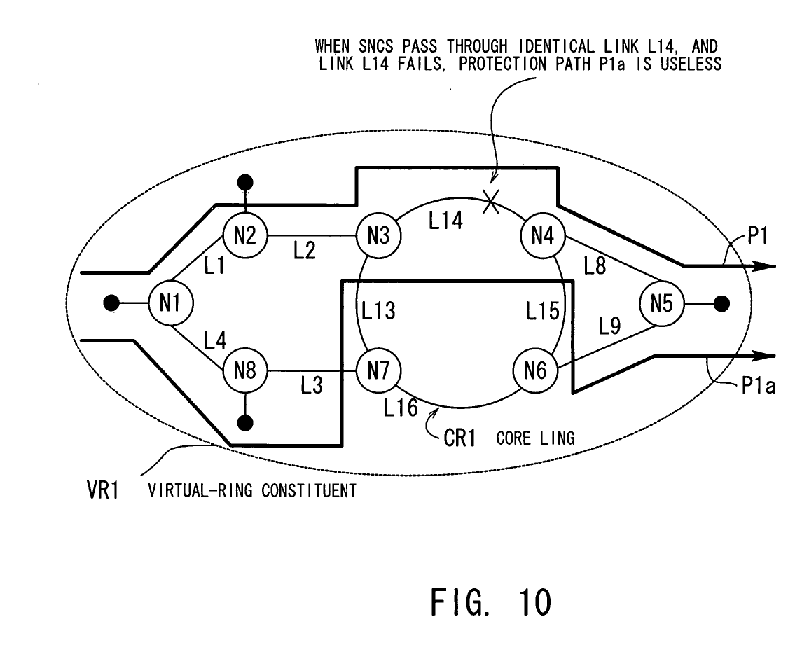

FIG. 10 is a diagram illustrating a problem which can occur in the case where subnetwork connections pass through an identical link. Assume that the subnetwork connection SNC1 is selected as the subnetwork connection connecting the branch connection points b1 and b5, and the subnetwork connection SNC2a is selected as the subnetwork connection connecting the branch connection points b2 and b6. In this case, the two subnetwork connections SNC1 and SNC2a pass through the same link L14.

In the above situation, it is assumed that a working path P1 is established as illustrated in FIG. 10, i.e., the working path P1 is indicated by the node numbers as N1 [symbol] N2 [symbol] N3 [symbol] N4 [symbol] N5. In addition, since the two subnetworks pass through the link L14, a protection path P1a for detouring at the time of trouble is established as illustrated in FIG. 10, i.e., as indicated by the node numbers as N1 [symbol] N8 [symbol] N7 [symbol] N3 [symbol] N4 [symbol] N6 [symbol] N5. In this specification, each path is defined as a transmission path from an ingress node to an egress node.

In the above situation, when a trouble occurs in the link L14, both of the working path P1 and the protection path P1a fail, and therefore it is impossible to perform the protection control. Thus, according to the present invention, subnetwork connections are established so as to pass through different links from each other.

Next, details of the operations in step S4, in which subnetwork connections are generated so as to pass through different links, are explained below.

First, the virtual-network generation unit 13 extracts branch connection points b1, b2, b5, and b6 from the branch information table T1, and then searches the connection information table T3 for branch connection points between which subnetwork connections are to be generated, in the cyclic order of the node numbers in the core ring CR1, e.g., in the order of N3 [symbol] N4 [symbol] N6 [symbol] N7 [symbol] N3 [symbol] . . .

By the above search, first the branch connection point b1 is obtained, and then the branch connection point b5 is obtained. Next, by referring to the core information table T2 based on the information on the branch connection points b1 and b5, the virtual-network generation unit 13 recognizes that it is possible to generate a subnetwork connection in the path b1-N3-L14-N4-b5. That is, the path b1-N3-L14-N4-b5 is obtained from the core-ring structure information in the core information table T2, as a path between the node N3 corresponding to the branch connection point b1 and the node N4 corresponding to the branch connection point b5, and therefore the first subnetwork connection is generated through the path b1-N3-L14-N4-b5.

On the other hand, the branch information table T1 shows that the branch connection point b5 belongs to the branch network BR2, to which the branch connection point b6 also belongs. Therefore, the connection information table T3 is searched from the branch connection point b6, and the branch connection point b2 is found next. Then, by referring to the core information table T2 based on the information on the branch connection points b6 and b2, the virtual-network generation unit 13 recognizes that it is possible to generate a subnetwork connection in the path b6-N6-L16-N7-b2. That is, the path b6-N6-L16-N7-b2 is obtained from the core-ring structure information in the core information table T2, as a path between the node N6 corresponding to the branch connection point b6 and the node N7 corresponding to the branch connection point b2, and therefore the second subnetwork connection is generated through the path b6-N6-L16-N7-b2.

As described above, the search for all of the branch connection points is completed, and the processing in FIG. 8 is also completed. The virtual ring VR1 generated as above is registered in a virtual-network information table T4.

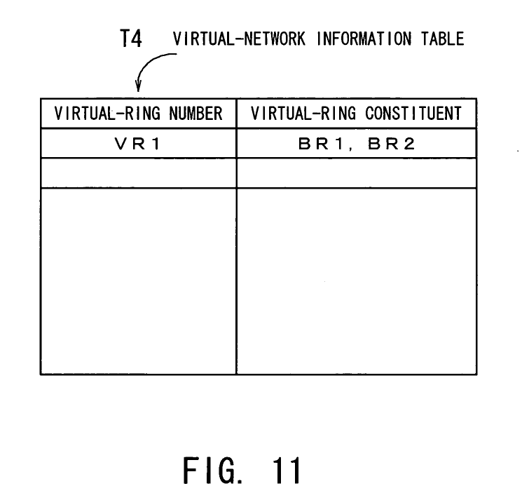

FIG. 11 is a diagram illustrating an example of the virtual-network information table T4. The virtual-network information table T4 is a table provided for the table management unit 12 managing information on the structures of virtual networks after generation of the virtual networks. The virtual-network information table T4 includes the fields of “VIRTUAL-RING NUMBER” and “VIRTUAL-RING CONSTITUENT.” In the example of FIG. 11, the branch networks BR1 and BR2 are indicated as constituents of the virtual ring VR1.

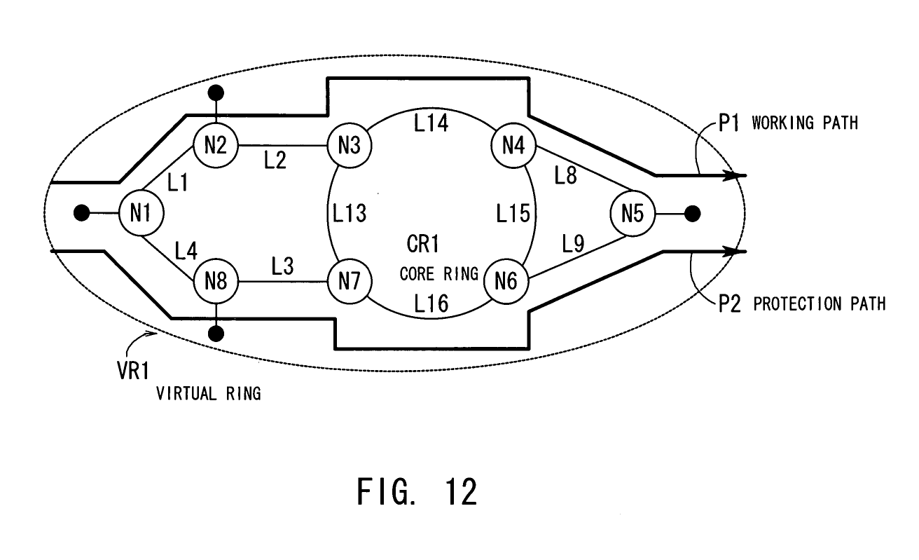

Next, a relationship between generation and protection of subnetwork connections in a core ring is explained below. FIG. 12 is a diagram illustrating a situation in which a working path and a protection path are established through the virtual ring VR1. In the case where the node N1 is an ingress node, and the node N5 is an egress node, the working path P1 is established through the nodes N1, N2, N3, N4, and N5, and the protection path P2 is established through the nodes N1, N8, N7, N6, and N5.

In the above situation, according to the present invention, a channel which is not protected in the core ring CR1 is preferentially selected for a subnetwork connection which is established in the core ring CR1 for the working path P1 in the virtual ring VR1.

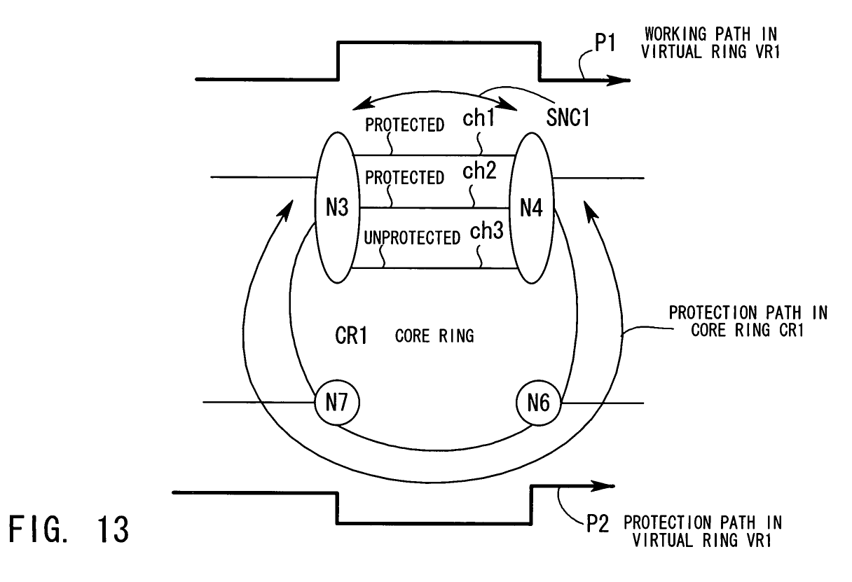

FIG. 13 is a diagram provided for explaining a reason why an unprotected channel is selected. In the following explanations, the link L14 between the nodes N3 and N4 in the core ring CR1, through which the working path P1 passes, is taken as an example. It is assumed that there are three channels (ch1 through ch3) between the nodes N3 and N4, the channels ch1 and ch2 are protected in the core ring CR1, and the channel ch3 is not protected in the core ring CR1.

A channel being protected in the core ring CR1 means that the current path of the channel can be detoured by transmitting information through another path in a different direction in the core ring CR1 when a trouble occurs in the current path of the channel. For example, when the line of the channel ch1 is currently used for transmission of information from the node N3 to the node N4, and fails due to a trouble, the failed line can be detoured by transmitting the information to the node N4 through the path N3 [symbol] N7 [symbol] N6 [symbol] N4.

In the case where a subnetwork connection SNC1 corresponding to the working path P1 in the virtual ring VR1 is established between the nodes N3 and N4 in the core ring CR1, generally, one of the channels ch1 through ch3 is required to be selected. At this time, if one of the channels ch1 and ch2, which are protected in the core ring CR1, is selected, double protection occurs.

For example, in the case where the subnetwork connection SNC1 in the virtual ring VR1 is established in the channel ch1, when the channel ch1 fails due to a trouble, the subnetwork connection SNC1 is protected in the core ring CR1, and is also protected by the protection path P2 in the virtual ring VR1. That is, the channel ch1 is doubly protected, and the network resource is inefficiently used.

Therefore, according to the present invention, a channel which is not protected in the core ring CR1 is preferentially selected for a subnetwork connection which is to be established in the virtual ring VR1.

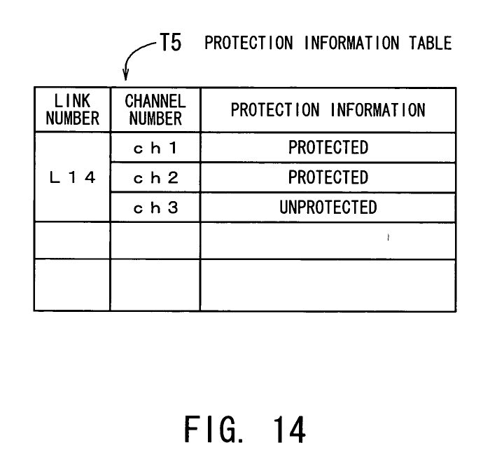

FIG. 14 is a diagram illustrating an example of a protection information table T5. The protection-information table T5 is managed by the table management unit 12, and includes the fields of “LINK NUMBER,” “CHANNEL NUMBER,” and “PROTECTION INFORMATION.”

The virtual-network generation unit 13 generates a subnetwork connection by preferentially selecting a channel which is not protected in the core ring CR1, based on the information indicated in the protection-information table T5.

Next, establishment of a path in the virtual ring VR1 is explained below. When the virtual-network generation unit 13 establishes a path in the virtual ring VR1, the virtual-network generation unit 13 registers setting information in a path-information table, and the table management unit 12 manages the path-information table.

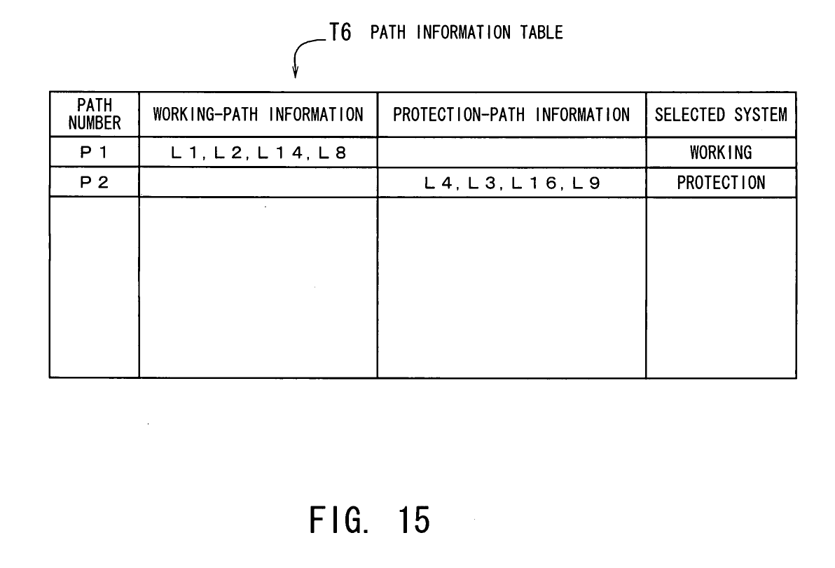

FIG. 15 is a diagram illustrating an example of the path information table T6. The path-information table T6 is managed by the table management unit 12, and includes the fields of “PATH NUMBER,” “WORKING-PATH INFORMATION,” “PROTECTION-PATH INFORMATION,” and “SELECTED SYSTEM.” The path-information table T6 in FIG. 15 indicates that, for example, the path P1 is established through the links L1, L2, L14, and L8, and used as a working path.

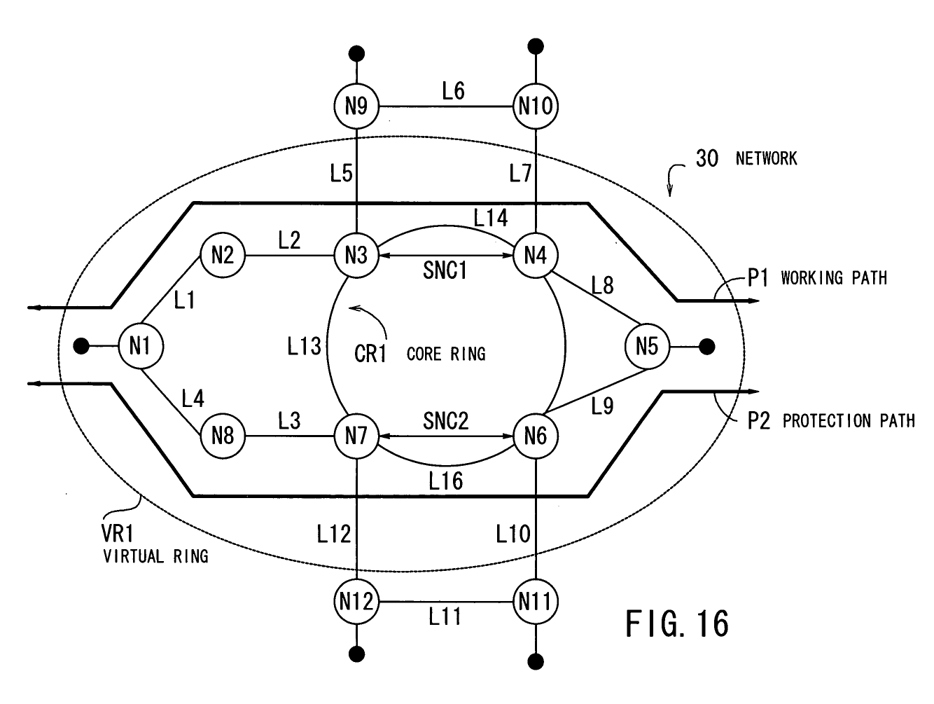

FIG. 16 is a diagram illustrating an example of generation of the virtual ring VR1. In FIG. 16, the virtual ring VR1 is established in the network 30. The subnetwork connections necessary for generation of the virtual ring VR1 are the subnetwork connection SNC1 connecting the nodes N3 and N4 and the subnetwork connection SNC2 connecting the nodes N6 and N7. In addition, the working path P1 and the protection path P2 are established as illustrated in FIG. 16.

Addition of Branch Network

Although the virtual ring VR1 is generated as explained above, hereinbelow operations for adding a new branch network to the virtual ring VR1 are explained.

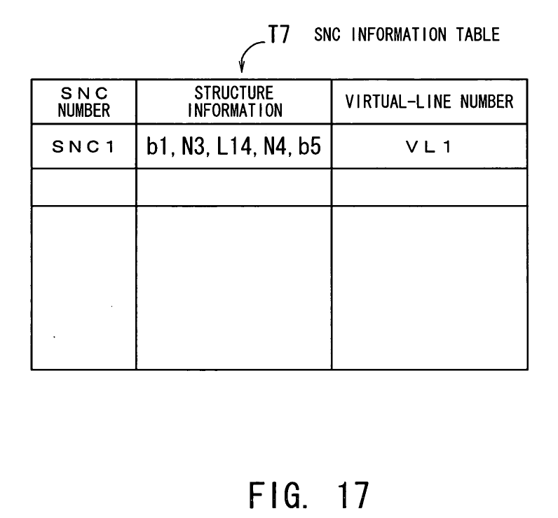

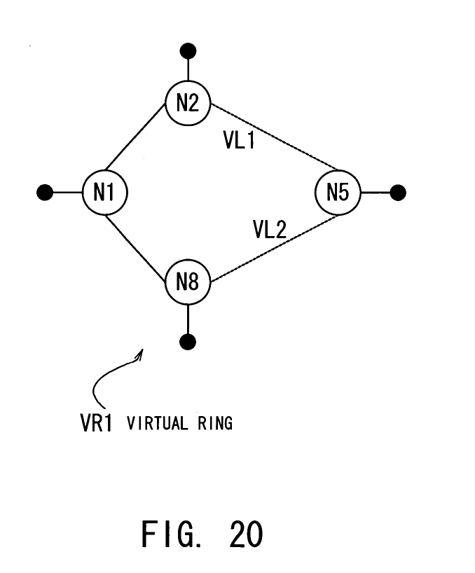

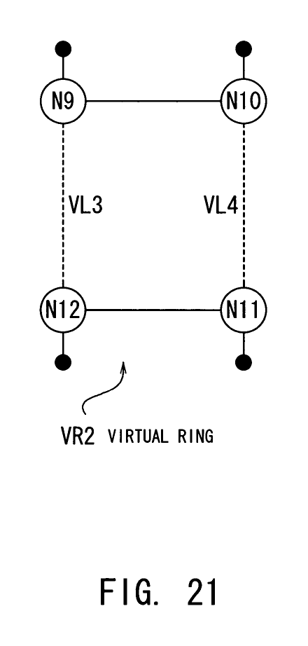

FIG. 17 is a diagram illustrating an example of an SNC information table T7. The SNC information table T7 is managed by the table management unit 12, and includes the fields of “SNC NUMBER,” “STRUCTURE INFORMATION,” and “VIRTUAL-LINE NUMBER.” The virtual lines are explained later with reference to FIGS. 20 and 21.

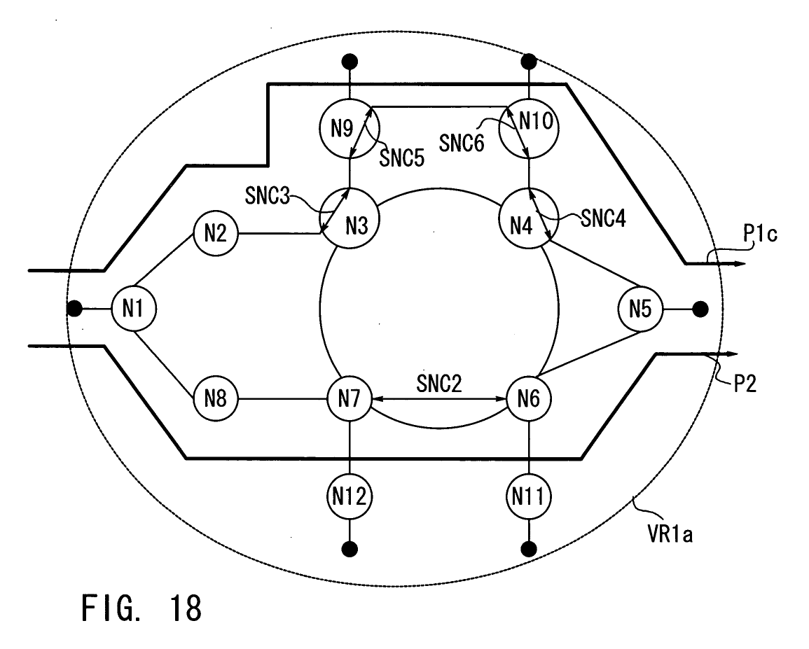

FIG. 18 is a diagram illustrating an example of addition of a branch network to the virtual ring VR1. In the example of FIG. 18, a branch network BR3 is newly added to the virtual ring VR1 so as to generate a virtual ring VR1a.

When the branch network BR3 is added, paths of subnetwork connections which connect branch connection points of the branch network BR3 and branch connection points of the virtual ring VR1 are determined. In other words, subnetwork connections which are required to be changed from the current virtual ring VR1 are determined.

As illustrated in FIG. 18, in order to add the branch network BR3, the subnetwork connection SNC1 is required to be changed. At this time, according to the SNC information table T7, the link L14 is associated with the subnetwork connection SNC1. In addition, according to the path-information table T6, the working path P1 passes through the link L14.

Therefore, first, the working path P1 is switched to the protection path P2, and the subnetwork connection SNC1 is removed. Further, subnetwork connections SNC3 and SNC4 are newly generated in the nodes N3 and N4, and subnetwork connections SNC5 and SNC6 are generated in the nodes N9 and N10, through which the new working path P1c passes.

That is, the subnetwork connection SNC1 connecting the nodes N3 and N4 is removed, and a subnetwork connection SNC3 connecting the nodes N2 and N9 is generated in the node N3, and a subnetwork connection SNC4 connecting the nodes N5 and N10 is generated in the node N4. In addition, subnetwork connections SNC5 and SNC6 (which connect the nodes N3, N9, N10, and N4) are established in the nodes N9 and N10, respectively. Thereafter, a branch number indicating the added branch network is added to the information in the field of “VIRTUAL-RING CONSTITUENT” in the virtual-network information table T4, and the path-information table T6 is changed so that the field of “WORKING-PATH INFORMATION” for the working path P1 indicates “L1, L2, L5, L6, L7, L8.”

Removal of Branch Network

Next, operations for removal of a branch network are explained below. When a branch network is removed from a virtual ring, paths of subnetwork connections which connect branch connection points of the branch network to be removed and branch connection points of the virtual ring VR1 are determined. In other words, subnetwork connections which are required to be changed from the current virtual ring VR1 are determined.

In addition, paths which are affected by the above removal of the branch network are switched to other paths, subnetwork connections in the core ring are changed, and subnetwork connections in the removed branch network are removed. Further, the corresponding branch number is deleted from the virtual-network information table T4.

Addition of Node

When a node is added to a branch network, at least one link which is temporarily disconnected is extracted from the branch information table T1, a path for which the disconnected link is selected is searched for in the path-information table T6, and then the selection is switched to another path. Thereafter, at least one necessary subnetwork connection is established in the added node, and the node and necessary links are added to the branch information table T1.

Removal of Node

Similarly to the case of addition of a node, when a node is removed from a branch network, at least one link which is temporarily disconnected is extracted from the branch information table T1, a path for which the disconnected link is selected is searched for in the path-information table T6, and then the selection is switched to another path. Then, the node and accompanying links are deleted from the branch information table T1.

Display of Virtual Ring

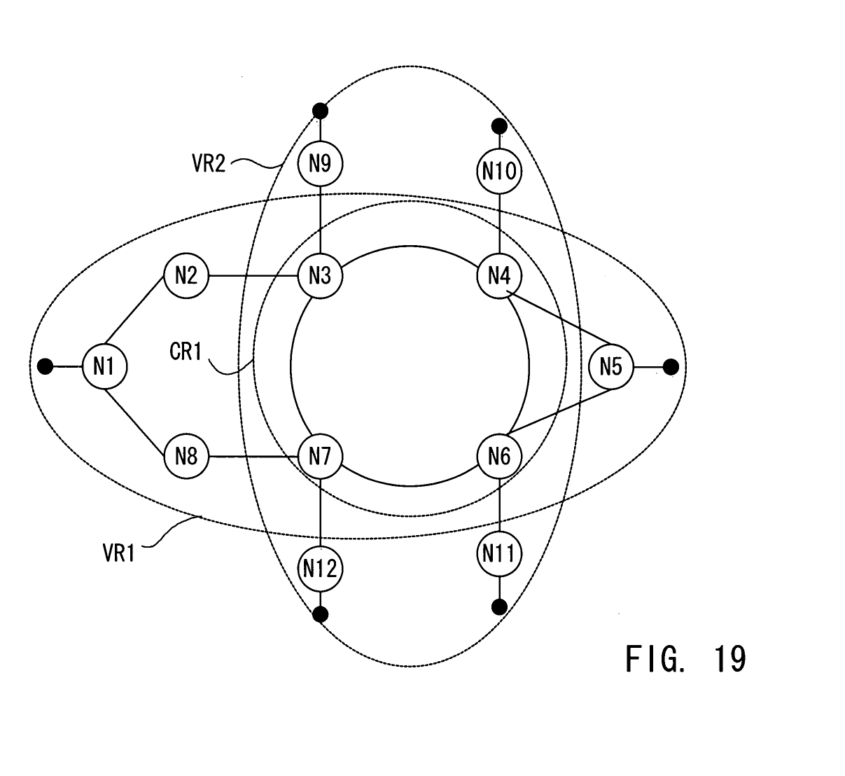

Next, operations for displaying the virtual ring VR1 are explained below. The NMS 10 further comprises a virtual-network display unit for displaying at least one virtual ring constructed in the network. FIGS. 19 to 21 are diagrams each illustrating an example of display of a virtual ring. In the example of FIG. 19, the virtual rings VR1 and VR2 are displayed in such a manner that the core ring CR1 is displayed inside the virtual rings VR1 and VR2. On the other hand, in FIGS. 20 and 21, the virtual rings VR1 and VR2 are displayed in such a manner that the core ring CR1 is concealed.

In FIGS. 20 and 21, the dotted lines indicate virtual lines (virtual links) representing subnetwork connections. Specifically, subnetwork connections in the virtual ring VR1 are indicated by the virtual lines VL1 and VL2, and subnetwork connections in the virtual ring VR2 are indicated by the virtual lines VL3 and VL4.

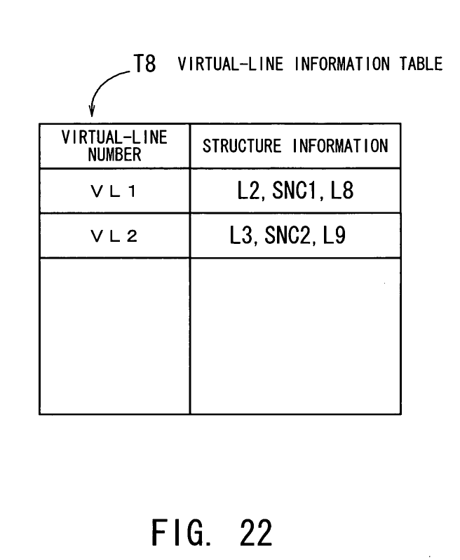

FIG. 22 is a diagram illustrating an example of a virtual-line information table T8. The virtual-line information table T8 is managed by the table management unit 12, and includes the fields of “VIRTUAL-LINE NUMBER” and “STRUCTURE INFORMATION.”

When a trouble occurs in a link, a subnetwork connection related to the trouble is extracted from the SNC information table T7, and a virtual line corresponding to the link in which the trouble occurs can be identified based on the virtual-line information table T8. Thus, the virtual-network display unit displays trouble information with the virtual line corresponding to the link in which the trouble occurs (for example, by changing the color or the type of the displayed virtual line) in order to notify the operator of the virtual line corresponding to the link in which the trouble occurs.

Advantages of the Invention

As explained above, according to the present invention, a network is decomposed into at least one core-ring network constituted by nodes and links which are connected so as to form a ring, and branch networks connected to the at least one core-ring network. Then, a virtual ring is generated by combining a plurality of branch networks. Therefore, it is possible to significantly reduce the amount of work which the operator is required to do for registering or changing a virtual ring, or adding or removing a node. That is, usability and efficiency in management and maintenance of the network can be improved.

Although a ring network (virtual ring) is taken as an example of a virtual network in the above explanations on generation of the virtual network, the virtual network is not limited to the ring network. That is, the present invention can be applied to generation of a virtual network having an arbitrary topology.

In addition, as explained above, in the network management system according to the present invention, a network is decomposed into network components, and information on the decomposition is managed by being tabulated. Then, a virtual network is generated, as a new area to be managed, by combining network components based on the information managed in tables. Therefore, the amount of bothersome work for generating a virtual network as an area to be managed is significantly reduced. Thus, it is possible to improve efficiency in management and maintenance of the network, and usability and operability of the network management system.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A network management system for managing a network, comprising:
a network decomposition unit which decomposes said network into network components;
a table management unit which manages information on decomposition of the network into said network components by tabulating the information on decomposition; and
a virtual-network generation unit which generates a virtual network as a new area to be managed, by combining said network components based on information managed by said table management unit.

2. The network management system according to claim 1, wherein said network decomposition unit decomposes said network into elements, and groups the elements into said network components, which include at least one core network and branch networks, and said virtual-network generation unit automatically generates said virtual network by combining ones of the branch networks.

3. The network management system according to claim 2, wherein said table management unit comprises,
a branch information table for managing information on structures of said branch networks,
a core information table for managing information on at least one structure of said at least one core network,
a connection information table for managing information on connections between the at least one core network and the branch networks, and
a virtual-network information table for managing information on a structure of said virtual network after generation of the virtual network.

4. The network management system according to claim 3, wherein said branch information table stores branch numbers indicating said branch networks, and said virtual-network generation unit automatically generates said virtual network by combining said ones of the branch networks when ones of the branch numbers corresponding to the ones of the branch networks are externally designated.

5. The network management system according to claim 2, wherein said virtual-network generation unit generates subnetwork connections in one of said at least one core network which are necessary for generation of said virtual network, in such a manner that the subnetwork connections share no link.

6. The network management system according to claim 2, wherein said table management unit further comprises a protection information table which contains information on protection of channels between nodes in the at least one core network, and said virtual-network generation unit generates subnetwork connections by preferentially selecting ones of the channels which are not protected, based on the protection information table.

7. The network management system according to claim 2, wherein when a branch network is added to said virtual network, said virtual-network generation unit changes a structure of the virtual network by determining at least one path in the virtual network which is affected by addition of the branch network, switching said at least one path to at least one other path, changing subnetwork connections in one of said at least one core network after the switching, and thereafter making settings for connecting paths to nodes in the added branch network.

8. The network management system according to claim 2, wherein when a branch network is removed from said virtual network, said virtual-network generation unit changes a structure of the virtual network by determining at least one path in the virtual network which is affected by removal of the branch network, switching said at least one path to at least one other path, changing subnetwork connections in one of said at least one core network after the switching, and thereafter removing subnetwork connections related to said at least one path from nodes in the removed branch network.

9. The network management system according to claim 3, wherein when a node is added to a branch network in said virtual network, said virtual-network generation unit changes a structure of the virtual network by determining at least one path in the virtual network which is affected by addition of the node, switching said at least one path to at least one other path, thereafter making settings for connecting paths to the added node, and adding information on the added node to said branch information table.

10. The network management system according to claim 3, wherein when a node is removed from a branch network in said virtual network, said virtual-network generation unit changes a structure of the virtual network by determining at least one path in the virtual network which is affected by removal of the node, switching said at least one path to at least one other path, and thereafter removing information on the removed node from said branch information table.

11. The network management system according to claim 2, further comprising a virtual-network display unit which displays said virtual network by generating virtual lines based on connections between nodes in said ones of branch networks and subnetwork connections in one of said at least one core network which connect the ones of branch networks.

12. The network management system according to claim 11, wherein when a trouble occurs in a link, and a failure of a subnetwork connection is detected, said virtual-network display unit displays information on the failure with one of said virtual lines corresponding to the subnetwork connection.

13. A virtual-network generation method for generating a virtual network in a network, comprising the steps of:
(a) decomposing said network into network components;
(b) tabulating information on decomposition of the network into said network components; and
(c) generating said virtual network as a new area to be managed, by combining said network components based on said information tabulated in step (b).

14. The virtual-network generation method according to claim 13, wherein in step (a), said network is decomposed into elements, and the elements are grouped into said network components, which include at least one core network and branch networks, and
in step (c), said virtual network is automatically generated by combining ones of the branch networks.

15. The virtual-network generation method according to claim 14, wherein said information on decomposition is managed by using,
a branch information table for managing information on structures of said branch networks,
a core information table for managing information on at least one structure of said at least one core network,
a connection information table for managing information on connections between the at least one core network and the branch networks, and
a virtual-network information table for managing information on a structure of said virtual network after generation of the virtual network.

16. The virtual-network generation method according to claim 15, wherein said branch information table stores branch numbers indicating said branch networks, and in step (c) said virtual network is automatically generated by combining said ones of the branch networks when ones of the branch numbers corresponding to the ones of the branch networks are externally designated.

17. The virtual-network generation method according to claim 14, wherein in step (c), subnetwork connections in one of said at least one core network which are necessary for generation of said virtual network are generated in such a manner that the subnetwork connections share no link.

18. The virtual-network generation method according to claim 14, wherein in step (c), subnetwork connections are generated by preferentially selecting ones of the channels which are not protected, based on a protection information table which contains information on protection of channels between nodes in the at least one core network, and said virtual-network generation unit.

19. The virtual-network generation method according to claim 14, wherein when a branch network is added to said virtual network, a structure of the virtual network is changed by determining at least one path in the virtual network which is affected by addition of the branch network, switching said at least one path to at least one other path, changing subnetwork connections in one of said at least one core network after the switching, and thereafter making settings for connecting paths to nodes in the added branch network.

20. The virtual-network generation method according to claim 14, wherein when a branch network is removed from said virtual network, a structure of the virtual network is changed by determining at least one path in the virtual network which is affected by removal of the branch network, switching said at least one path to at least one other path, changing subnetwork connections in one of said at least one core network after the switching, and thereafter removing subnetwork connections related to said at least one path from nodes in the removed branch network.

21. The virtual-network generation method according to claim 15, wherein when a node is added to a branch network in said virtual network, a structure of the virtual network is changed by determining at least one path in the virtual network which is affected by addition of the node, switching said at least one path to at least one other path, thereafter making settings for connecting paths to the added node, and adding information on the added node to said branch information table.

22. The virtual-network generation method according to claim 15, wherein when a node is removed from a branch network in said virtual network, a structure of the virtual network is changed by determining at least one path in the virtual network which is affected by removal of the node, switching said at least one path to at least one other path, and thereafter removing information on the removed node from said branch information table.

23. The virtual-network generation method according to claim 14, further comprising a step of displaying said virtual network by generating virtual lines based on connections between nodes in said ones of branch networks and subnetwork connections in one of said at least one core network which connect the ones of branch networks.

24. The virtual-network generation method according to claim 23, wherein when a trouble occurs in a link, and a failure of a subnetwork connection is detected, information on the failure is displayed with one of said virtual lines corresponding to the subnetwork connection.
